(19) United States
(12) Patent Application Publication
(10) Pub. No.: US 2025/0189419 A1
(43) Pub. Date: Jun. 12, 2025

(54) FLOATING PLATFORM SYSTEM FOR MECHANICAL TESTING OF GELS AND TISSUES

(71) Applicant: The Regents of the University of Colorado, a body corporate, Denver, CO (US)

(72) Inventor: Tyler TUTTLE, Denver, CO (US)

(21) Appl. No.: 18/972,502

(22) Filed: Dec. 6, 2024

Related U.S. Application Data
(60) Provisional application No. 63/607,827, filed on Dec. 8, 2023.

(51) Int. Cl. G01N 3/08

(52) U.S. Cl. CPC G01N 3/08; G01N 2203/0016; G01N 2203/0032; G01N 2203/0075; G01N 2203/0464; G01N 2203/0605; G01N 2203/0676

(57) ABSTRACT

A mechanical testing system for deformable samples, such as gels or tissues, is disclosed. The system includes a container for holding a liquid, and a floatable platform configured to float on the liquid. The platform includes attachments for connecting to a deformable sample and a force sensor assembly. The system allows for the application of unidirectional tension to the sample and the measurement of the resulting force by the force sensor assembly. The design of the system minimizes off-target forces and sample vibration, and allows for submerged testing and simultaneous imaging of the sample. The system is particularly suitable for testing small, soft materials such as extracellular matrix polymers.

### CROSS-REFERENCE TO RELATED APPLICATIONS

This Application claims priority to and the benefit of U.S. Provisional Patent Application Ser. No. 63/607,827, filed Dec. 8, 2023, and titled “FLOATING PLATFORM SYSTEM FOR MECHANICAL TESTING OF GELS AND TISSUES,” the entirety of which is incorporated herein by this reference.

### BACKGROUND

Biological tissues and extracellular matrices (ECMs) exhibit a wide range of mechanical properties that are integral to their function. These properties are influenced by the composition and organization of the ECM, as well as the interactions between cells and the ECM. Understanding these mechanical properties is of interest in the fields of tissue engineering and regenerative medicine, as they provide insights into the design of biomaterials and regenerative therapies.

Fibrin, for example, is a naturally occurring protein that forms a temporary matrix supporting blood clotting and wound healing. In vitro, fibrin gels can be created by combining fibrinogen and thrombin. These gels have been used in clinical settings as wound sealants due to their quick polymerization reactions and effective tissue adherence. Furthermore, fibrin gels have been utilized as scaffolds in tissue engineering applications.

Uniaxial tensile testing is a common method for characterizing the mechanical properties of tissues, ECMs, and other gels. This method involves applying a unidirectional tension to a sample and measuring the resulting force and/or sample deformation. However, the mechanical characterization of small, soft materials such as these can be challenging due to difficulties in handling small geometries and resolving forces of low magnitudes.

Moreover, the ability to simultaneously image the sample during mechanical testing can provide valuable insights into the microscale organization and deformation of the sample. Confocal microscopy is one imaging technique that can provide high-resolution images of the internal structure of a sample. However, integrating confocal microscopy or other imaging modalities with mechanical testing systems can be complex and requires careful design to minimize sample vibration and maintain sample hydration. Conventional mechanical testing systems are expensive, not easily customized, and not readily integrated with imaging functionality. Moreover, although certain custom approaches have been reported, these are typically complex and specific to a particular application or tissue type.

Accordingly, there is an ongoing need for mechanical testing systems that can accurately measure low forces, directly measure sample deformation, keep samples hydrated throughout testing, and allow for simultaneous imaging.

### SUMMARY

The disclosed mechanical testing system enables mechanical testing of a deformable sample (e.g., a tissue sample and/or gel) while the sample is submerged. The disclosed system beneficially maintains the sample in a desired hydrated condition, enables granular measurement of applied forces, enables simultaneous imaging of the sample, and minimizes vibration/movement for more effective imaging.

The mechanical testing system includes a container configured for holding a liquid and including an attachment point (referred to as the container-sample attachment point) for attaching a first end of the sample to an inner wall of the container. The system also includes a floatable platform disposed within the container and configured to float upon a liquid placed within the container. The floatable platform includes a first attachment point for attaching to the second end of the sample, and a second attachment point for attaching to the force sensor assembly.

In use, the first side of the deformable sample is attached to the container-sample attachment point in the container, and the second side of the deformable sample is attached to the first attachment point of the floatable platform. The second attachment point of the floatable platform for attachment to the force sensor assembly is opposite the first attachment point (along an axial direction). Unidirectional tension applied to the floatable platform is thereby transmitted to the deformable sample.

The container may comprise an open upper side to allow imaging (e.g., confocal microscopy) of the deformable sample during application of tension to the deformable sample. The deformable sample may comprise a gel and/or tissue, such as fibrin. The force sensor assembly may be configured to measure forces in the millinewton (mN) range. The floatable platform may be configured to minimize off-target forces, moments, and/or sample vibration during application of unidirectional tension.

The floatable platform may comprise a plurality of buoys. The floatable platform may include an overhanging arm that extends over a sidewall of the container when the floatable platform is placed within the container so that the attachment point to the force sensor assembly can be aligned at a substantially similar vertical height as the first attachment.

The floatable platform may omit additional attachments (e.g., springs) other than those used for attaching to the deformable sample and to the force sensor assembly. This beneficially allows the floatable platform to be free to move upon the liquid in the axial direction without inducing moments and/or forces transverse to the axial direction.

An example mechanical testing method includes mounting a first end of the deformable sample to a container sample attachment within a container that holds a liquid in which the deformable sample is submerged, mounting a second end of the deformable sample to a floatable platform configured to float upon the liquid within the container, applying unidirectional tension to the floatable platform and therefore to the deformable sample, and measuring a force applied to the deformable sample while the deformable sample is submerged. The method may further comprise imaging the deformable sample during the application of unidirectional tension. The imaging may include use of a confocal microscope and/or other upright microscope. The deformable sample may be a tissue and/or gel. The floatable platform may comprise a plurality of stabilizer buoys.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the disclosure will become apparent and more readily appreciated from the following description, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale.

FIG. 1 is a schematic view of a mechanical testing system, showing the arrangement of the deformable sample, floatable platform, force sensor assembly, and container.

FIG. 2A illustrates a more detailed view of an example mechanical testing system according to the FIG. 1 design, showing the deformable sample, floatable platform, force sensor assembly, and container.

FIG. 2B shows the floatable platform of the mechanical testing system of FIG. 2A, illustrating buoy elements and attachment points for attaching to the deformable sample and force sensor assembly.

FIG. 2C shows the container of the mechanical testing system of FIG. 2A, illustrating the container-sample attachment point and limit members.

FIG. 3 illustrates another example of a mechanical testing system, showing a different design of the floatable platform with an overhanging arm.

FIG. 4A shows a more detailed view of an example mechanical testing system according to the FIG. 3 design, showing the floatable platform with overhanging arm.

FIG. 4B shows the floatable platform of the mechanical testing system of FIG. 4A, showing the overhanging arm and the alignment of the attachment points at substantially the same vertical height.

FIG. 4C shows the container of the mechanical testing system of FIG. 4A, illustrating the container-sample attachment and limit members.

FIGS. 5A and 5B illustrate another example of a mechanical testing system in which two floatable platforms are included.

FIG. 6 illustrates another example of a mechanical testing system in which four floatable platforms are included and which is capable of providing biaxial testing of a sample.

### DETAILED DESCRIPTION

### Mechanical Testing System Overview

The mechanical testing system disclosed herein is designed to test deformable samples, such as gels and/or tissues while the samples are submerged in a desired testing liquid. This liquid environment is beneficial for maintaining the hydration of the sample during testing, which is particularly relevant for biological samples such as tissues or gels. The system allows for direct force measurement, high signal-to-noise ratio, negligible off-target forces, submerged testing, an open top face for imaging, and minimized sample vibration. These features make the system particularly suitable for testing small, soft materials such as embryonic tissues and extracellular matrix polymers, such as gels and tissues having a stiffness between 0.6 kPa and 60 kPa.

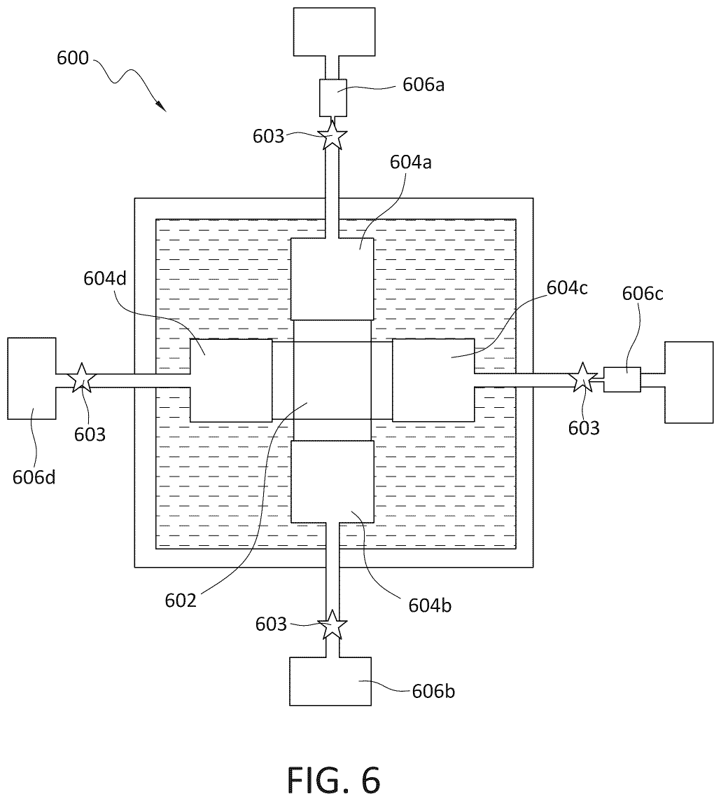

Although most of the examples described herein relate to testing biological tissues and gels, it will be understood that the disclosed systems and methods can also be utilized to test (and optionally image) any sample that can be submerged during testing. Similarly, while most of the examples described herein relate to testing uniaxial tension, the disclosed systems and methods are also applicable for testing uniaxial compression. Moreover, as shown in certain embodiments (see, e.g., FIG. 6), systems and methods can be configured for applying controlled tension or compression along multiple axes, such as biaxial testing.

Compared to the disclosed mechanical testing systems, conventional mechanical testing systems known in the art suffer from several limitations. Many systems require upright rather than horizontal configurations which complicates the imaging process. Additionally, many systems require open air testing, indirect force measurement, for estimation based on displacement tracking, or the need for submersible load cells or hanging clamps which can induce damaging loads on sensitive load cells. Mechanical testing systems disclosed herein may be used to overcome these limitations.

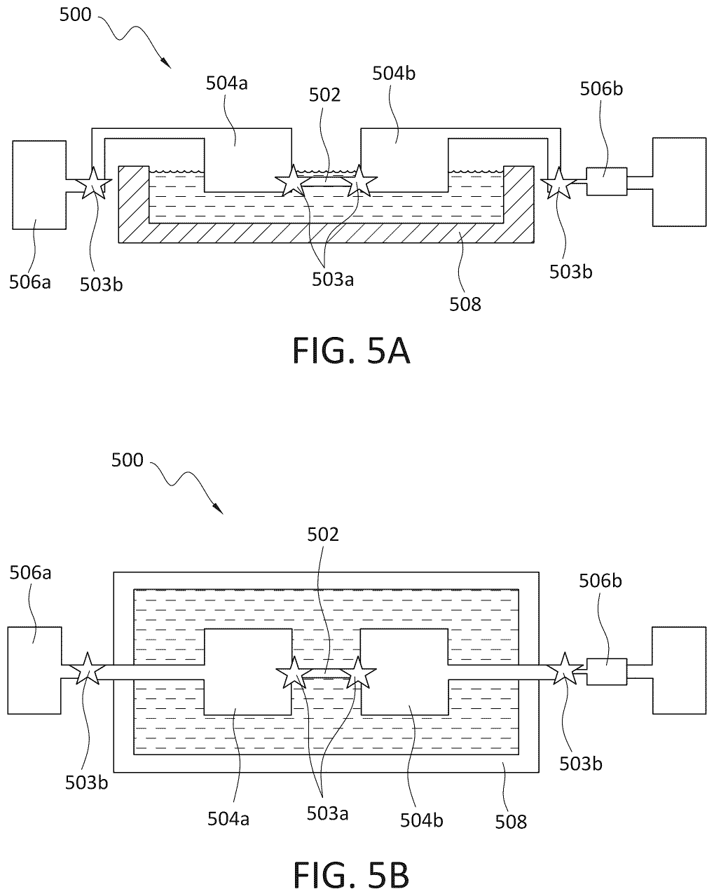

In one embodiment, the system includes a container configured for holding a liquid. The liquid may comprise a water-based solution (e.g., Hank's Buffered Salt Solution (HBSS)) or other solution conducive to replicating the in-vivo environment of the sample or the environment in which the sample is planned to be used, providing a physiologically relevant mechanical assessment. The container includes a container sample attachment for mounting a first side of a deformable sample. The system also includes a floatable platform configured to be disposed within the container and configured to float when a liquid is placed within the container. The floatable platform includes a first attachment configured for mounting a second side of the deformable sample, and a second attachment opposite the first attachment along an axial direction. The second attachment is configured for attachment to a force sensor assembly. Tension applied to the deformable sample along the axial direction is measurable by the force sensor assembly (also referred to herein as an actuator/sensor assembly). The force sensor assembly may include an actuator and a force sensor (e.g., a load cell and/or other suitable sensor). The force sensor assembly may be configured to measure forces in the millinewton (mN) range. For example, the force sensor assembly may measure forces having a measurement granularity of within 100 mN, or within 75 mN, or within 50 mN, or with 25 mN, or within 10 mN, or within 5 mN, or within 1 mN, or within 0.5 mN, or within 0.1 mN. In some multi-platform embodiments (see, e.g., FIGS. 5A-6), some actuator/sensor assemblies may omit a force sensor (e.g., because only one is needed for a given testing axis).

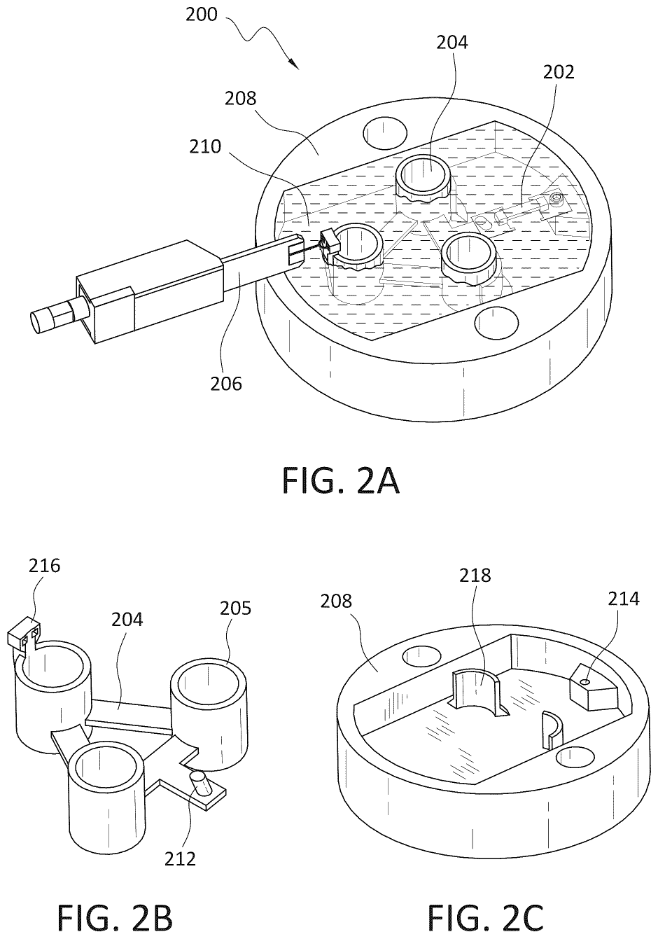

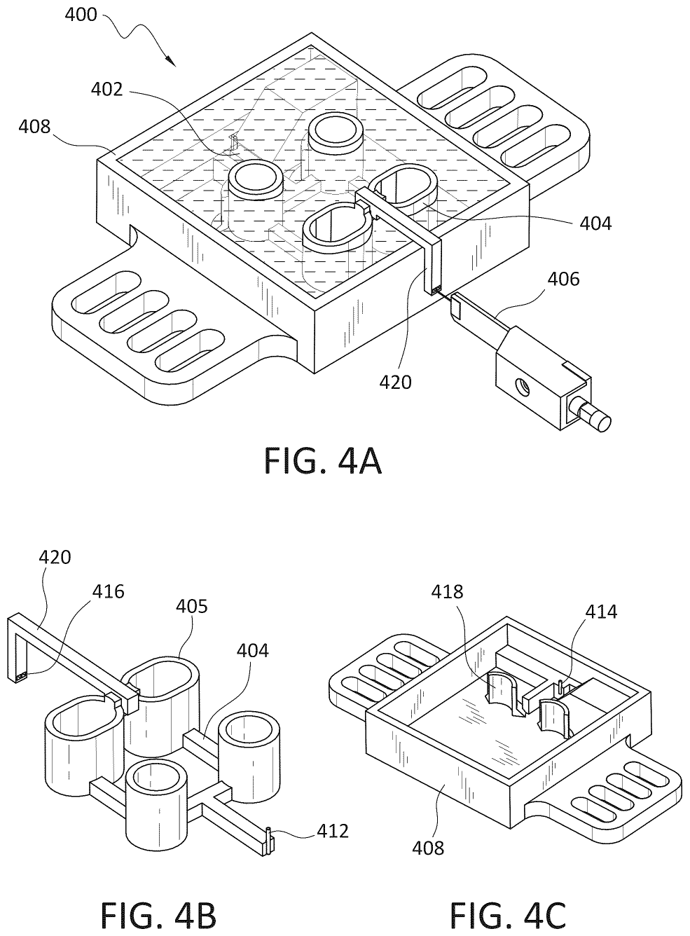

The system may be configured to attach to samples of various shapes. For example, the sample may be formed into a slab or a band or may be formed in an oblong shape or may have an irregular shape. The sample may comprise an excision from tissue of an organism. The attachment points between the sample and the container and/or floatable platform may comprise a clamp attached to either or both ends of the sample. Alternatively, the attachment point may comprise connecting pins (sec FIGS. 2A-2B and 4A-4C). The sample may be mounted by extending the connecting pins through one or more portions of the sample. In other embodiments, the attachment may be formed by a sample formed into a band and extending about the pins of the attachment points.

The container of the system is designed to be open on an upper side. This allows for imaging of the deformable sample during the application of tension. The imaging can be performed using a confocal microscope, for example, which provides high-resolution images of the internal structure of the sample. Other imaging modalities may additionally or alternatively be included. Examples include a stereo microscope, multiphoton microscope, or any upright microscope capable of proper positioning above the sample. The container of the system may comprise or be configured to attach to a mirror (e.g., oriented at approximately 45 degrees relative to a surface of the fluid) to enable simultaneously top and side viewing of the sample for geometric evaluation.

The force sensor assembly of the system may include an actuator attachable to the force sensor opposite from the deformable sample. The actuator is configured to apply unidirectional tension or compression to the deformable sample.

The floatable platform of the system is designed to minimize off-target forces and sample vibration during the application of unidirectional tension. This is achieved because the floatable platform is free to move upon the liquid in the axial direction with minimal friction, minimal moments, and minimal forces transverse to the axial direction.

Although any suitable floatable structure may be utilized as the floatable platform, the floatable platform may include a plurality of buoys to provide buoyancy and stability to the structure. In one embodiment, the floatable platform includes an overhanging arm that extends over a sidewall of the container when the floatable platform is placed within the container. The overhanging arm allows the attachment to the force sensor assembly to be disposed at a height that is substantially equal to the height of the attachment to the sample, minimizing any moments or off-axis forces when unidirectional tension is applied.

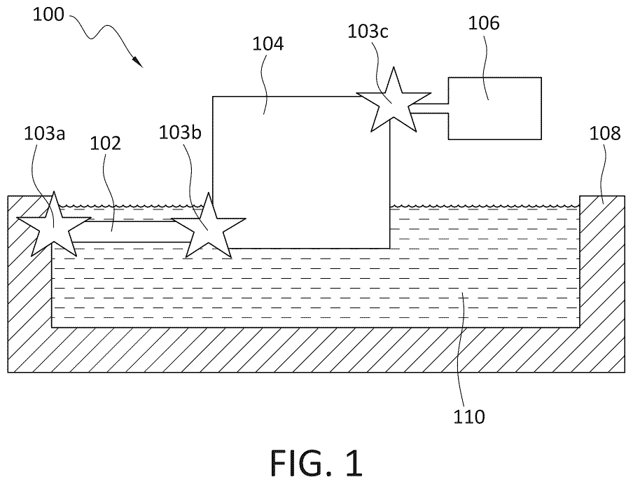

The mechanical testing system 100, as shown in FIG. 1, includes a container 108 configured for holding a liquid 110. Container 108 includes a container-sample attachment for attachment to a first side of a deformable sample 102 (i.e., at attachment point 103a). The deformable sample 102 can be a gel or tissue, such as fibrin, and is designed to undergo unidirectional tension, while submerged, during testing. The container 108 is open on an upper side, allowing for imaging of the deformable sample 102 during the application of tension. This open design facilitates the use of imaging techniques, such as confocal microscopy and/or other imaging modalities disclosed herein, to provide high-resolution images of the internal structure of sample 102 during testing.

Within container 108, a floatable platform 104 is configured to float when the liquid 110 is placed within container 108. The floatable platform 104 includes a first attachment configured for attachment to a second side of the deformable sample 102 (i.e., at attachment point 103b) and a second attachment (opposite the first attachment along an axial direction) for attachment to the force sensor assembly 106 (i.e., at attachment point 103c).

In some cases, force sensor assembly 106 may include an actuator (e.g., linear actuator). The actuator is attachable to the force sensor opposite from the deformable sample and is configured to apply unidirectional tension to the deformable sample 102. This configuration allows for precise control over the application of tension, facilitating accurate and repeatable testing of the deformable sample 102.

The floatable platform 104 is designed to minimize off-target forces and sample vibration during the application of unidirectional tension. This is achieved because the floatable platform 104 is free to move upon the liquid in the axial direction with minimal friction and without inducing forces transverse to the axial direction. In some cases, the floatable platform 104 may include a plurality of buoys to provide buoyancy and stability to the structure.

As shown in FIGS. 2A-2C, a first end of the deformable sample 202 is attached to a container-sample attachment 214 within the container 208. A second end of the deformable sample 202 can be attached to a first attachment 212 of the floatable platform 204. The floatable platform 204 may be designed to be disposed within the container 208 and to float on the liquid 210 when the liquid 210 is placed within the container 208.

The floatable platform 204 may include a second attachment 216 opposite the first attachment 212 along the axial direction (i.e., along the direction in which tension is applied during testing). This second attachment 216 is configured for attachment to force sensor assembly 206. The force sensor assembly 206 functions to apply unidirectional tension to the floatable platform 204 and therefore to the deformable sample 202. The force sensor assembly 206 also measures the force applied to the deformable sample 202 during the application of tension.

In some cases, the floatable platform 204 may include a plurality of buoy elements 205 to provide buoyancy and stability to the structure of platform 204. These buoy elements 205 can be strategically positioned to ensure that it remains stable and level during testing, even when subjected to the forces associated with the application of unidirectional tension to the deformable sample 202. The use of multiple buoy elements 205 can help to distribute the buoyant force evenly across the floatable platform 204, preventing it from tilting or capsizing during testing. This design can help to maintain the position and orientation of the floatable platform 204 during testing, ensuring consistent and accurate force measurements.

As shown in FIG. 2C, the container 208 may include a container-sample attachment 214 for securing one end of the sample 202. In some cases, the container 208 may also include one or more limit members 218. These limit members 218 protrude upward and/or sideways from the inner surfaces of the container 208. The limit members 218 are configured to space the floatable platform 204 from the container-sample attachment 214 so as to prevent movement of the floatable platform toward the container-sample attachment 214. This spacing defines the baseline distance between the floatable platform 204 and the container-sample attachment 214.

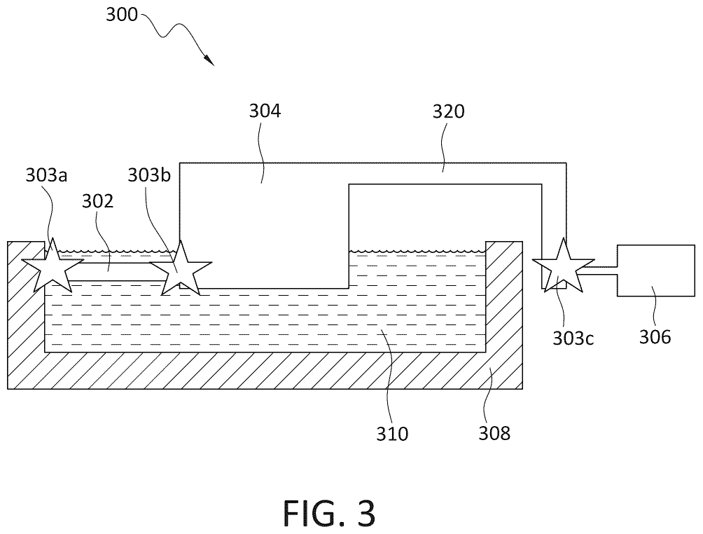

Turning to another example of a mechanical testing system 300, as shown in FIG. 3, the system 300, similar to systems 100 and 200 above, may include an attachment point 303a between the container 308 and the sample 302 and a floatable platform 304 designed to float within a liquid 310 but having a different design. In this example, the floatable platform 304 includes an overhanging arm 320 that extends over a sidewall of the container 308 when the floatable platform 304 is placed within the container 308.

The overhanging arm 320 allows the attachment point 303c between platform 304 and the force sensor assembly 306 to be made at a height that is substantially the same as the attachment point 303b between platform 304 and the deformable sample 302. Although this can, in some embodiments, be accomplished without an overhanging arm 320 (e.g., by placing the attachment point 303c within the liquid and using a waterproof force sensor), the illustrated design enables such functionality without requiring submersion of the force sensor assembly 306.

This alignment of the attachment points 303b, 303c minimizes any moments or off-axis forces that could otherwise be induced during the application of unidirectional tension to the deformable sample 302 and enables force measurements in line with deformation of the sample 302. Other features discussed above in relation to systems 100 and 200 are applicable to system 300.

FIGS. 4A-4C illustrate a more detailed view of an example system 400 including a floatable platform 404 with an overhanging arm 420 according to the design schematically illustrated by FIG. 3. The system 400 allows the attachment 416, which is configured for attachment to the force sensor assembly 406, to be disposed at a height that is substantially equal to the height of the attachment 412, which is configured for attachment to one side of the deformable sample 402.

The floatable platform 404 may comprise buoy elements of different sizes so as to compensate for the overhanging arm 420 and ensure stable floating of the floatable platform 404. As illustrated, the buoy elements disposed closer to the overhanging arm 420 may be larger (e.g., have a larger diameter) than the buoy elements disposed closer to the sample 402.

Features described in the context of other embodiments can also be included in system 400. For example, system 400 can include a container 408 with a container-sample attachment 414 and one or more limit members 418. The floatable platform 404 can include a plurality of buoy elements 405.

FIGS. 5A and 5B illustrate side and top views, respectively, of another example of a mechanical testing system 500 in which two floatable platforms 504aand 504b are included. In this example, a first end of the sample 502 can be connected to a first floatable platform 504a and a second end of the sample 502 can be connected to a second floatable platform 504b (i.e., at attachment points 503a). The first and second floatable platforms 504a, 504b are disposed opposite each other and are configured to provide tension or compression to the deformable sample along a common axis, such that the attachment points 503b between the first and second floatable platforms 504a, 504b and the actuators/sensor assemblies 506a, 506b are at substantially similar vertical height. The sample 502 thus does not need to be connected to the container 508. Respective actuator/sensor assemblies 506a, 506b can also be included. Typically, only one of the actuator/sensor assemblies includes a force sensor, though both may include a force sensor in certain embodiments.

FIG. 6 illustrates another example of a mechanical testing system 600 in which four floatable platforms 604a-604d are included. In this example, a first floatable platform 604a is disposed opposite a second floatable platform 604b along a first axis, and a third floatable platform 604c is disposed opposite a fourth floatable platform 604d along a second axis. The sample 602 can be connected to all four floatable platforms such that biaxial tension (or compression) can be applied to the sample 602. Respective actuator/sensor assemblies 606a-606d can also be included, in which each actuator/sensor assembly 606a-606d may be attached to a separate floatable platform 604a-604d at attachment points 603. Typically, only one of the actuator/sensor assemblies 606a-606d in each axis pair includes a force sensor, though both may include a force sensor in certain embodiments.

### Additional Terms & Definitions

As used herein, the term “measurement granularity” refers to the granularity at which measurements may be accurately resolved and distinguished from other measurements. For example, a measurement granularity of 10 mN indicates that applied forces that differ by 10 mN could be effectively distinguished from one another, and a measurement granularity of 0.1 mN indicates that a measured force of 0.1 mN can be distinguished from a measured force of 0.2 mN.

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

It will also be appreciated that embodiments described herein may also include properties and/or features (e.g., components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

When the terms “about,” “approximately,” “substantially,” or the like are used in conjunction with a stated amount, value, or condition, it may be taken to mean an amount, value or condition that deviates by less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “an element”) may also include two or more such referents.

The embodiments disclosed herein should be understood as comprising/including disclosed components, and may therefore include additional components not specifically described. Optionally, the embodiments disclosed herein are essentially free or completely free of components that are not specifically described. That is, non-disclosed components may optionally be completely omitted or essentially omitted from the disclosed embodiments.

1. A mechanical testing system, comprising:
a container configured for holding a liquid, the container including a container-sample attachment for attachment to a first side of a deformable sample; and
a floatable platform configured to be disposed within the container and configured to float when a liquid is placed within the container, wherein the floatable platform includes
(i) a first attachment configured for attachment to a second side of the deformable sample, and
(ii) a second attachment opposite the first attachment along an axial direction, the second attachment being configured for attachment to a force sensor assembly,
wherein tension or compression applied to the deformable sample along the axial direction is measurable by the force sensor assembly.

2. The system of claim 1, further comprising the force sensor assembly and/or the deformable sample.

3. The system of claim 1, wherein the container comprises an open upper side to allow imaging of the deformable sample during application of tension or compression to the deformable sample.

4. The system of claim 1, further comprising an imaging assembly configured to image the deformable sample during application of tension or compression.

5. The system of claim 4, wherein the imaging assembly comprises an upright microscope.

6. The system of claim 1, wherein the force sensor assembly comprises an actuator attachable to the force sensor opposite from the deformable sample and configured to apply tension or compression to the deformable sample.

7. The system of claim 1, wherein the deformable sample comprises a gel and/or tissue, such as fibrin.

8. The system of claim 1, wherein the force sensor assembly is configured to measure forces with a measurement granularity of within 100 mN.

9. The system of claim 1, wherein the floatable platform is configured to minimize off-target forces and/or sample vibration during application of unidirectional tension.

10. The system of claim 1, wherein the container is configured such that the deformable sample is submerged in a liquid during application of unidirectional tension.

11. The system of claim 1, wherein the floatable platform comprises a plurality of buoy elements.

12. The system of claim 1, wherein the floatable platform includes an overhanging arm that extends over a sidewall of the container when the floatable platform is placed within the container.

13. The system of claim 1, wherein the second attachment is aligned at a substantially similar vertical height as the first attachment.

14. The system of claim 1, wherein the container comprises a limit member configured to space the floatable platform from the container-sample attachment and prevent movement of the floatable platform toward the container-sample attachment.

15. The system of claim 1, wherein the floatable platform omits attachments other than for attaching to the deformable sample and to the force sensor assembly such that the floatable platform is free to move upon the liquid in the axial direction without inducing forces transverse to the axial direction.

16. The system of claim 1, the system comprising multiple floatable platforms, wherein a first floatable platform is connectable to a first side of the deformable sample and a second floatable platform is connectable to a second side of the deformable sample.

17. The system of claim 16, wherein the first and second floatable platforms are disposed opposite each other and are configured to provide tension or compression to the deformable sample along a common axis.

18. The system of claim 17, further comprising a third floatable platform and a fourth floatable platform.

19. The system of claim 18, wherein the third and fourth floatable platforms are disposed opposite each other and are configured to provide tension or compression to the deformable sample along a common axis that is transverse to a common axis of the first and second floatable platforms, the multiple floatable platforms enabling application of biaxial tension or compression to the deformable sample.

20. A method for mechanically testing a deformable sample, the method comprising:
mounting a first end of the deformable sample to a container-sample attachment within a container that holds a liquid in which the deformable sample is submerged;
mounting a second end of the deformable sample to a floatable platform configured to float upon the liquid within the container;
applying unidirectional tension to the floatable platform and therefore to the deformable sample; and
measuring a force applied to the deformable sample while the deformable sample is submerged.
